(19) United States
(12) Patent Application Publication
(10) Pub. No.: US 2024/0404017 A1
(43) Pub. Date: Dec. 5, 2024

(54) Neural Network Image Enhancement

(71) Applicants: Hewlett-Packard Development Company, L.P., Spring, TX (US); Purdue Research Foundation, West Lafayette, IN (US)

(72) Inventors: Xiaoyu Xiang, West Lafayette, IN (US); Qian Lin, Palo Alto, CA (US); Jan Allebach, West Lafayette, IN (US); Tianqi Guo, San Diego, CA (US)

(73) Assignees: Hewlett-Packard Development Company, L.P., Spring, TX (US); Purdue Research Foundation, West Lafayette, IN (US)

(21) Appl. No.: 18/698,757

(22) PCT Filed: Oct. 13, 2021
(86) PCT No.: PCT/US2021/054721

§ 371 Date: Apr. 4, 2024

(51) Int. Cl. G06T 5/60; G06T 3/4046; G06T 7/10

(52) U.S. Cl. CPC G06T 5/60; G06T 3/4046; G06T 7/10; G06T 2207/20084

(57) ABSTRACT

In some examples, a computing device can include a processor resource and a non-transitory memory resource storing machine-readable instructions stored thereon that, when executed, cause the processor resource to identify a base resolution of a captured image having a base image quality, perform, via an individual neural network, neural network calculations on the captured image to form an enhanced image having an resolution that is higher than the base resolution and image quality that is higher than the base image quality.

### BACKGROUND

A computing device can allow a user to utilize computing device operations for work, education, gaming, multimedia, and/or other uses. Computing devices can be utilized in a non-portable setting, such as at a desktop, and/or be portable to allow a user to carry or otherwise bring the computing device along while in a mobile setting. These computing devices can be connected to scanner devices, cameras, and/or other image capture devices to convert physical documents into digital documents for storage and/or reproduction.

In some examples, the computing device can be coupled to a camera and/or a microphone. The camera can be utilized to capture images of objects and the computing device can be utilized to store and/or display the images captured by the imaging device. The microphone can be utilized to capture audio emitted near the computing device by converting sound waves into electrical energy variations which can be amplified, transmitted, and/or stored.

### BRIEF DESCRIPTION OF THE DRAWINGS

FIG. 1 illustrates an example of a computing device for neural network image enhancement.

FIG. 2 illustrates an example of a memory resource storing instructions for neural network image enhancement.

FIG. 3 illustrates an example of a system including a computing device for neural network image enhancement.

FIG. 4 illustrates an example of a method for neural network image enhancement.

### DETAILED DESCRIPTION

Computing devices are used for various purposes, such as for business and/or recreational use. As used herein, the term “computing device” refers to an electronic system having a processor resource and a memory resource. Examples of computing devices can include, for instance, a laptop computer, a notebook computer, a desktop computer, an all-in-one (AIO) computer, networking device (e.g., router, switch, etc.), and/or a mobile device (e.g., a smart phone, tablet, personal digital assistant, smart glasses, a wrist-worn device such as a smart watch, etc.), among other types of computing devices. As used herein, a mobile device refers to devices that are (or can be) carried and/or worn by a user.

In some examples, the computing device can be communicatively coupled to an image capture device, a printing device, a multi-function printer/scanner device, and/or other peripheral devices. In some examples, the computing device can be communicatively coupled to the image capture device to provide instructions to the image capture device and/or receive data from the image capture device. For example, the image capture device can be a scanner, camera, and/or optical sensor that can perform an image capture operation and/or scan operation on a document to collect digital information related to the document. In this example, the image capture device can send the digital information related to the document to the computing device.

In some examples, the digital information can be data stored on a memory resource of the computing device and/or a remote memory resource to be utilized at a later time. Memory resources to store the digital information can be limited or costly for organizations. In some examples, storing large quantities of digital information can be expensive, especially when relatively large resolutions are utilized. For example, digital information related to documents that were captured using a relatively high resolution can take up more memory resources than digital information related to documents that were captured using a relatively low resolution.

Moreover, when the computing device is included a video conference utilizing a video conferencing application, performance (e.g., a frame rate) can be impacted (e.g., reduced) when a large amount of data is being communicated during the video conference. The reduction in performance (e.g., reduction in frame rate) can become perceptible to an end user and thus an end-user experience can be impacted.

As such, images such as digital photos and/or video frames in some instances are downscaled, compressed, and then converted (e.g., with codecs) when saved on devices or transmitted over the Internet. Inevitably this results in loss of details, amplification of noise, and/or the introduction of compression artifacts. As a result, when the images (e.g., photos) subsequently are printed on paper and/or the videos subsequently are viewed (e.g., on high-definition screens), the downscaled and compressed images often have a visually unpleasant appearance.

Some approaches attempt to mitigate the visually unpleasant appearance by employing image super-resolution (e.g., to increase a resolution) or enhancement techniques (e.g., to restore the details and recover the image quality of the photos and video frames). For instance, some approaches employ an individual neural network exclusively for denoise, deblur, or compression removal. However, such approaches do not have an upsampling layer to change the spatial resolutions of the images, and thus will not suffice to increase resolution.

Accordingly, approaches in the present disclosure employ neural networks (e.g., a convolutional neural network (CNN)) to achieve two tasks (super-resolution and image quality enhancement) in an individual processing step. As such, approaches herein are readily adopted in training modern image or video restoration networks, and the trained networks can be used for preprocessing before sending to photo printers, or to restore video frames on the receiver's end over video conference calls, among other possible applications, such as use with scanners/copiers. Notably, the use of one neural network (e.g., an individual CNN) during inference saves processing time (e.g., obtains an enhanced image quicker than other approaches and/or improves image quality/resolution, and yet utilizes a relatively small neural network, in contrast to approaches that employ multiple neural networks to sequentially alter image quality and image resolution.

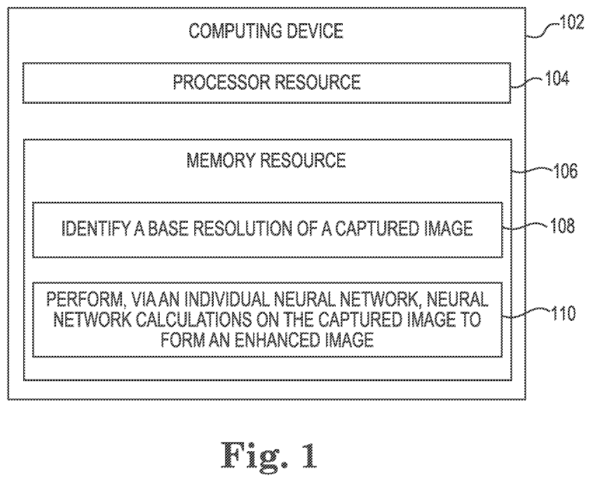

FIG. 1 illustrates an example of a computing device 102 for neural network image enhancement. The computing device 102 can include a processor resource 104 communicatively coupled to a memory resource 106. As described further herein, the memory resource 106 can include instructions 108, 110 that are executable by the processor resource 104 to perform particular functions.

In some examples, the computing device 102 can be associated with an image capture device (e.g., camera, printer, scanner, optical sensor, etc.) and/or printing device. As used herein, an image capture device can refer to a device that is capable of digitizing a physical document and/or otherwise capturing an image/video. For example, the image capture device can convert a physical document to a digital document and/or reproduce a copy of the physical document. In some examples, the physical document can include an image on a print medium (e.g., paper, plastic, etc.) and a digital document can include a virtual image from the physical document that can be displayed on a display coupled to the computing device 102 and/or displayed on a display of a different computing device that is communicatively coupled to the computing device 102.

As used herein, the processor resource 104 can include, but is not limited to: a central processing unit (CPU), an application specific integrated circuit (ASIC), a field programmable gate array (FPGA), a metal-programmable cell array (MPCA), a semiconductor-based microprocessor, or other combination of circuitry and/or logic to orchestrate execution of instructions 108, 110. In other examples, the computing device 102 can include instructions 108, 110 stored on a machine-readable medium (e.g., memory resource 106, non-transitory computer-readable medium, etc.) and executable by a processor resource 104. In a specific example, the computing device 102 utilizes a non-transitory computer-readable medium storing instructions 108, 110 that, when executed, cause the processor resource 104 to perform corresponding functions.

In some examples, the computing device 102 can include instructions 108 that can be executed by a processor resource 104 to identify a base resolution of a captured image having a base image quality. The base resolution can be identified based on metadata or other information associated with the captured image. As used herein, “resolution” refers to a fineness of detail in a bitmap image and can, for instance, be measured in pixels per inch (ppi).

In some instances, the base resolution can be lower than an original resolution of the image. For instance, in some examples, a captured image has undergone compression such as lossy image compression. As used herein, “lossy image compression” refers to compression that reduces an image resolution of the captured image from an original resolution to the base resolution, for instance, to decrease an amount of data/size of file associated with the captured image from an amount of data/size of file associated with the original image. Examples of lossy compression formats include JPEG formats, MPEG formats, among other types of lossy compression formats. For example, JPEG compression can be utilized for images such as photos and MPEG (e.g., MPEG-4) compression can be employed for videos. In this way, the images (e.g., individual photos images and/or video frames) can be downsampled from an original resolution (e.g., 1080p, etc.) to a pre-defined resolution (e.g., 360p, 720p, etc.) that is lower than the original resolution and compressed in blocks to reduce the resulting file size.

In any case, a user may desire to increase a resolution of an image from a base resolution to an enhanced (higher) resolution. The resolution of the enhanced image is at least 1.1 times greater than the base resolution of the base image. For instance, in some examples, the increased resolution (e.g., 1080p) of the enhanced image is at least 1.5 times greater than the base resolution (e.g., 720p) of the base image. For example, the resolution of the enhanced image can be increased by 1.5×, 2.0×, 2.5×, 3.0×, 3.5×, or 4.0× greater than the base resolution, among other possible values. Although specific resolutions and specific amounts of increase (e.g., 1.5×) are discussed, the present disclosure is not limited to these resolutions/amounts of increase of resolution. That is, other resolutions can be utilized without departing from the disclosure.

In some examples, the computing device 102 can include instructions 110 that can be executed by a processor resource 104 to perform, via an individual neural network, a plurality of neural network calculations on the captured image to form an enhanced image. The individual neural network is a CNN and the plurality of neural network calculations are a plurality of CNN calculations, in some instances.

As mentioned, the use of only one neural network (e.g., an individual CNN) during inference saves processing time (e.g., increases a frame rate in the video communication context)/utilizes a relatively small neural network and/or improves image quality/resolution, in contrast to approaches the employ multiple models to sequentially alter image quality and image resolution. For example, some other approaches employ dedicated models to perform individual tasks such as SRCNN and SRGAN for individual image super resolution, Noise2Noise and Noise2Void for noise removal, or ARCNN for removal of JPEG compression artifacts.

In contrast, approaches herein in some examples perform the neural network calculations, as detailed herein, to balance between an amount of increase in the increased resolution with an amount of increase in the increased image quality of the enhanced image. As such, approaches herein lead to formation of enhanced images with a combination of increased resolution and increased image quality than can be realized by sequentially employing a plurality of distinct dedicated neural networks/models tailored to provide image resolution or image quality enhancement.

In some examples, the computing device 102 can include instructions 110 that can be executed by a processor resource 104 to perform the plurality of neural network calculations during inference. For instance, each of the plurality of neural network calculations can be performed during inference. Performing the plurality of neural network calculations during inference can reduce an amount of computational overhead associated with forming enhanced images, as compared to other approaches that occur during neural network training.

The computing device 102 can include instructions 110 that can be executed by a processor resource 104 to perform a plurality of CNN calculations to segment the captured image into a plurality of image dimensions that have a given height and a given width. For instance, the instructions 110 can be executed by the processor resource 102, in some examples, to segment, via a convolution layer of the CNN, the captured image into a plurality of image dimensions have a given height, a given width, as detailed herein.

In some examples, forming the enhanced image with increased image quality can include sharpening feature boundaries dulled by the lossy image compression, reduction of noise imparted by the lossy image compression, reduction of compression artifacts imparted by the lossy image compression, or any combination thereof. For instance, in some examples, the enhanced image can have zero compression artifacts.

As mentioned, the computing device 102 can include instructions 110 that can be executed by a processor resource 104 to perform a plurality of CNN calculations to pool, via a pooling layer of the CNN, the plurality of image dimensions to form pooled image dimensions, extract features from the pooled image dimensions. For instance, the instructions 110 can be executed by the processor resource 102, in some examples, to pool the plurality of image dimensions using atrous spatial pyramid pooling (ASPP), as detailed herein. For instance, ASPP can include a context awareness component that permits readily located edges for sharpening operation, identification of local abnormal pixels (noise), and/or reconstruction of image details impacted by compression blocks such as those associated with lossy compression.

As mentioned, the computing device 102 can include instructions 110 that can be executed by a processor resource 104 to extract features from the pooled image dimensions. For instance, the instructions 110 can be executed by the processor resource 102, in some examples, to extract the features from the pooled image dimensions using a residual in a residual dense block (RRDB) approach.

As mentioned, the computing device 102 can include instructions 110 that can be executed by a processor resource 104 to perform subpixel convolution based on the extracted features and the pooled image dimensions to form an enhanced image. For instance, the instructions 110 can be executed by the processor resource 102, in some examples, to perform subpixel convolution based on the extracted features and the pooled image dimensions to form an enhanced image by way of utilization of efficient upscaling of feature maps in place of the traditional transposed convolutional layer. Such approaches can reduce computation costs, etc. For instance, in the context of real-time processing of live stream from the webcam (e.g., while utilizing a teleconferencing application) for video super-resolution and enhancement, this approach reduces computational cost and boosts the frame rate. As mentioned, having a higher frame rate can be desired to ensure a satisfactory end user experience, and yet still forms enhanced images, which further enhance the user experience.

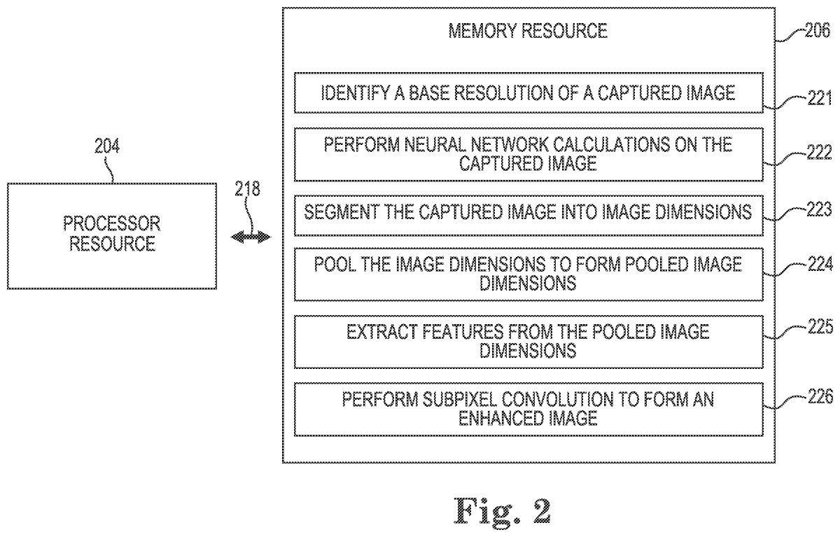

FIG. 2 illustrates an example of a memory resource 206 storing instructions for neural network image enhancement. In some examples, the memory resource 206 can be a part of a computing device or controller that can be communicatively coupled to a computing system that includes image capture devices and/or can include an image capture device. For example, the memory resource 206 can be part of a computing device 102 as referenced in FIG. 1 and communicatively coupled to an image capture device. In some examples, the memory resource 206 can be communicatively coupled to a processor resource 204 that can execute instructions 221, 222, 223, 224, 225, 226 stored on the memory resource 206. For example, the memory resource 206 can be communicatively coupled to the processor resource 204 through a communication path 218. In some examples, a communication path 218 can include a wired or wireless connection that can allow communication between devices and/or components within an individual device.

The memory resource 206 may be electronic, magnetic, optical, or another physical storage device that stores executable instructions. Thus, a non-transitory machine readable medium (MRM) (e.g., a memory resource 206) may be, for example, a non-transitory MRM comprising Random-Access Memory (RAM), read-only memory (ROM), an Electrically-Erasable Programmable ROM (EEPROM), a storage drive, an optical disc, and the like. The non-transitory machine readable medium (e.g., a memory resource 206) may be disposed within a controller and/or computing device. In this example, the executable instructions 221, 222, 223, 224, 225, 226 can be “installed” on the device. Additionally, and/or alternatively, the non-transitory machine readable medium (e.g., a memory resource) can be a portable, external or remote storage medium, for example, that allows a computing system to download the instructions 221, 222, 223, 224, 225, 226 from the portable/external/remote storage medium. In this situation, the executable instructions may be part of an “installation package”. As described herein, the non-transitory machine readable medium (e.g., a memory resource 206) can be encoded with executable instructions for neural network image enhancement.

The instructions 221, when executed by a processor resource such as the processor resource 204, can include instructions to identify the base resolution of a captured image having a base image quality, as detailed herein.

The instructions 221, when executed by a processor resource such as the processor resource 204, can include instructions that perform, via an individual CNN, a plurality of CNN calculations on the captured image to form an enhanced image having an increased resolution that is higher than the base resolution and an increased image quality that is higher than the base resolution. For instance, the CNN calculations can segment the captured image into image dimensions, pool the image dimensions to form pooled image dimensions, extract features from the pooled image dimensions, and/or, perform subpixel convolution based on the extracted features and the pooled image dimension to form the enhanced image, as detailed herein.

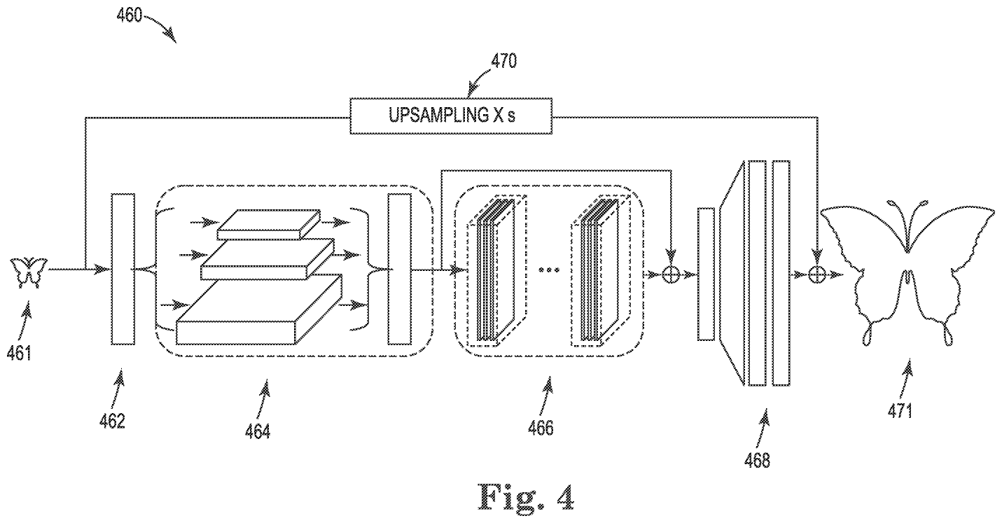

For instance, the instructions 223, when executed by a processor resource such as the processor resource 204, can include instructions to segment the image data into image dimensions have a given height (h), a given width (w). For instance, a convolution layer of a CNN can be employed to act as an initial feature extractor and segment a base image. For instance, as detailed in FIG. 4, a base image can be turned into image segments such as a 64*h*w tensor (f^{l}).

The instructions 224, when executed by a processor resource such as the processor resource 204, can pool the plurality of image dimensions to form pooled image dimensions. For instance, the instructions 222 can pool, via a pooling layer of the CNN, the plurality of image dimensions to form pooled image dimensions. For instance, pooling can include the extraction and integration of multiscale features with an atrous spatial pooling pyramid (ASPP). In such instances, dilation rates of each layer in the pyramid can be adjusted to extend the filter's perceptive field for extracting different ranges of context information, in which the largest field-of view should cover a given size of block such as an 8×8 block. In this way, any sampling overlap in different levels of the 3×3 convolutions are avoided. For instance, in some examples 1, 3, 4 are chosen as the dilation groups to balance between accurately retrieving local details and assimilating context information between adjacent blocks. However, other dilation group values are possible. The input tensors are sent to 3 layers of the pyramid: a 3×3 convolutional layer with dilation rate=1, a 3×3 convolutional layer with dilation rate=3, and a 3×3 convolutional layer with dilation rate=4. The outputs of these three layers are concatenated and aggregated by a 1×1 convolution. The ASPP process can be described by equation 1 (Eq 1), below.

$${fl}^{′} = [ C 3 \times 3 , 1 ⊗ fl \vert C 3 \times 3 , 3 ⊗ fl \vert C 3 \times 3 , 4 ⊗ fl ] ⊗ C 1 \times 1 , 1 \qquad ( Eq 1 )$$

where fl′ denotes the output feature (e.g., 64_h_w in size, among other possible sizes), C_{a×a,r} represents the parameters of a×a convolution with dilation rate r, and | is a concatenation operation.

The instructions 225, when executed by a processor resource such as the processor resource 204, can include instructions to extract features from the pooled image dimensions. For instance, in some examples, a RRDB (residual-in-residual dense block) is applied as the basic block for the reconstruction trunk. Compared with residual blocks, it densely connects the convolution layers to local groups while removing the batch normalization layer. In some examples, the reconstruction can include 20 RRDBs, although other quantities of RRDBs are possible.

The instructions 226, when executed by a processor resource such as the processor resource 204, can include instructions to perform subpixel convolution (i.e., Pixelshuffle) based on the extracted features and the pooled image dimension to form the enhanced image. For instance, after reconstruction, the image feature can be preprocessed by a 3×3 convolution layer before a PixelShuffle layer for upsampling. In such instances, the Pixelshuffle layer produces an HR image from LR (low resolution) feature maps directly with one upscaling filter for each feature map.

Compared with the other approaches, the PixelShuffle layer is faster (e.g., log₂ s² times faster) because of applying sub-pixel activation to convert most of the computations from the HR (high resolution) to the LR domain. The feature fl″ is turned into ac×sh×sw HR image by the PixelShuffle layer, which can be described by equation 2 (Eq. 2) and equation 3 (Eq. 3), below.

$${ISR}^{′} = PS ( WL ⊗ {fl}^{″} + bL ) \qquad ( Eq . 2 )$$

where WL denotes the convolution weights and bL the bias in the LR domain, PS is a periodic shuffling operator for rearranging the input LR feature tensor fl″ (c×s²×h×w) to a HR tensor of shape c×sh×sw:

$$PS ( T ) x , y , c = T [ \frac{x}{s} ] , [ \frac{y}{s} ] , c \cdot s \cdot mod ( y , s ) + c \cdot s \cdot mod ( x , s ) \qquad ( Eq . 3 )$$

Instead of directly outputting the high-resolution image, we process it through two 3×3 convolution layers for further enhancement. To make the major network focus on learning the high-frequency information in the input image, we bilinearly upsample the input LR image I^{LRLQ} and add it to form the final output G (^{LRLQ},Θ_{g}) as described in equation 4 (Eq. 4)

$$G ( ILRLQ , Θ g ) = ILRLQ ↑ s + ISR \qquad ( Eq . 4 )$$

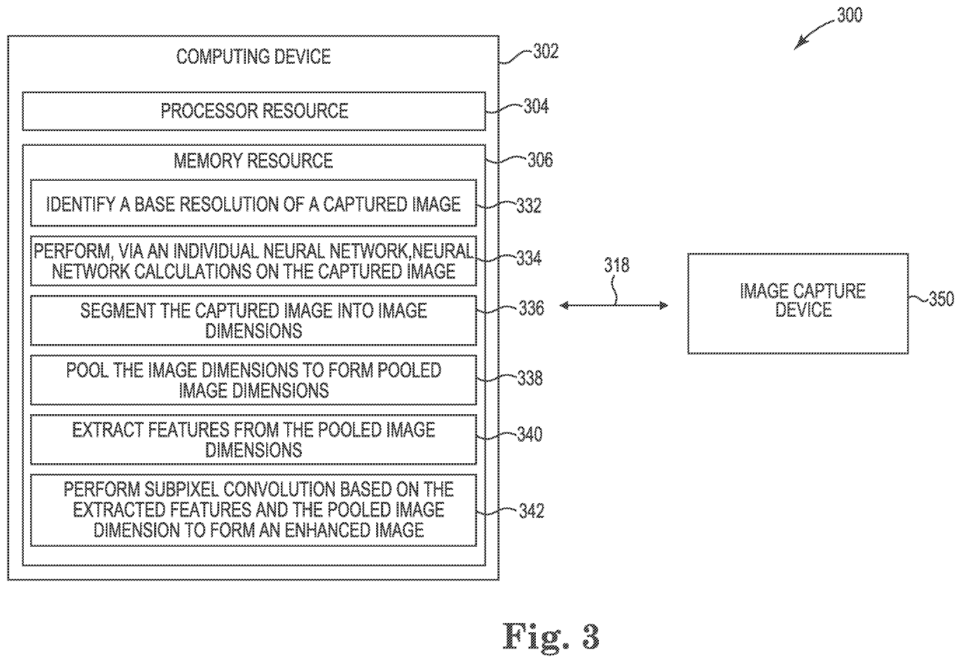

FIG. 3 illustrates an example of a system 300 including a computing device 302 for output resolution selections. In some examples the computing device 302 can be a device that includes a processor resource 304 communicatively coupled to a memory resource 306.

As described herein, the memory resource 306 can include or store instructions 332, 334, 336, 338, 340, 342, that can be executed by the processor resource 304 to perform particular functions.

In some examples, the image capture device 350 can be communicatively coupled to the computing device 302 through a communication path 318. In some examples, the computing device 302 can provide instructions to the image capture device 350 to perform particular functions. For example, the computing device 302 can select an output resolution to be utilized by the image capture device 350 or computing device 302 for performing processes for digital data on an image of a particular document. In this way, the computing device 302 can receive image data of an image of a document from the image capture device 350 and the computing device 302 can perform neural network image enhancement, as described herein. However, the captured image can be obtained from any source such as transmitted to the computing device via the internet via a video conferencing session.

In some examples, the image capture device 350 and computing device 302 can be part of the same device. For example, the image capture device 350 can be a portable image capture device that is capable of being transported to a plurality of locations. In other examples, the image capture device 350 and the computing device 302 can be separate and distinct devices such that the image capture device 350 can be located in a first location and the computing device 302 can be located in a second location.

In some examples, the computing device 302 can include instructions that can be executed by a processor resource 304 to receive image data of an image captured by the image capture device 350. In some examples, the computing device 302 can include instructions 332 that can be executed by a processor resource 304 to can identify a base resolution of a captured image having a base image quality, as detailed herein.

In some examples, the computing device 302 can include instructions 334 that can be executed by a processor resource 304 to perform, via an individual CNN a plurality of CNN calculations on the captured image to form an enhanced image having an increased resolution that is higher than the base resolution and an increased image quality that is higher than the base resolution, the CNN calculations, as detailed herein.

In some examples, the computing device 302 can include instructions 336 that can be executed by a processor resource 304 to segment the image data into image dimensions having a given height and a given width, as detailed herein. In some examples, the computing device 302 can include instructions 338 that can be executed by a processor resource 304 to pool the image dimensions to form pooled image dimensions, as described herein. In some examples, the computing device 302 can include instructions 340 that can be executed by a processor resource 304 to extract features from the pooled image dimensions, as described herein. In some examples, the computing device 302 can include instructions 342 that can be executed by a processor resource 304 to extract features from the pooled image dimensions, as described herein.

FIG. 4 illustrates an example of a method 460 for neural network enhancement. The method 460 can include receiving image data of captured image (i.e., a base image) 461, as described herein. For instance, the method 460 can include receiving image data of a captured image 461 from an image capture device.

In some examples, the method 460 can include receiving image data of a captured image 461 from an image capture device associated with a teleconferencing application executing on a computing device. That is, computing devices can be utilized as teleconference devices. As used herein, a teleconference device can be utilized to provide audio and/or video data to remote computing devices. In this way, a teleconference device can be a computing device that can communicate with remote computing devices and allow remote users to communicate through audio and/or video data transferred between computing devices.

In some instances, a plurality of computing devices can be utilized for a teleconference by connecting to a teleconference application. The teleconference application can include instructions that can be utilized to receive audio and/or video data from the plurality of computing devices and provide the audio and/or video data to each of the plurality of computing devices. In some examples, the teleconference application can be a teleconference portal that can be utilized by a plurality of computing devices to exchange audio and/or video data. As used herein, a teleconference portal can refer to a gateway for a website that can provide teleconferencing functions.

For instance, the method 460 can include capture of image data at a computing device during a live teleconference utilizing a plurality of computing device which are each participants in the teleconference application. In this way, an image (e.g., a low resolution image) captured and/or transmitted as part of the teleconference application can be enhanced, as detailed herein, to provide enhanced images which are viewable during the teleconference. For example, the method 460 can receive image data of an image from an image capture device of a first computing device included in a teleconference with a second computing device and communicatively coupled to that device and providing the enhanced image to the second computing device during the teleconference.

In some examples, the resolution of the enhanced image can be based on a threshold (minimum frame rate) to provide a visually satisfactory teleconferencing application experience to the user. For example, the enhanced image may be 1.5× times higher resolution or 2.0× higher resolution rather than a higher (e.g., 4.0×) resolution to ensure the size of a data associated with the enhanced image does not become too large to a point where the increased size (relative the captured image) negatively impacts a teleconference experience (e.g., imparts choppiness into the video of the teleconference).

The method 460 can include performing, via an individual convolutional CNN, a plurality of CNN calculations on the captured image to form an enhanced image 471 having an increased resolution that is higher than the base resolution and an increased image quality that is higher than the base resolution, as described herein.

The method 460 can employ an upsampling factor(s) 470. The upsampling factor can be a value equal to or greater than a value of a downsampling factor, in some examples. In any case, the method 460 can utilize the upsampling factor to form the enhanced image.

For instance, the method 460 at 462 can include segmenting the captured image 461 into image dimensions having a given height and a given width, as described herein. The method 460 at 464 can include pooling the image dimensions to form pooled image dimensions, as described herein. The method 460 at 466 can include extracting features from the pooled image dimensions, as described herein. The method 460 at 468 can include performing subpixel convolution based on the extracted features and the pooled image dimension to form the enhanced image, as detailed herein.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense.

The above specification, examples, and data provide a description of the system and method of the disclosure. Since many examples can be made without departing from the spirit and scope of the system and method of the disclosure, this specification merely sets forth some of the many possible example configurations and implementations.

What is claimed is:

1. A computing device, comprising:
a processor resource; and
a non-transitory memory resource storing machine-readable instructions stored thereon that, when executed, cause the processor resource to:
identify a base resolution of a captured image having a base image quality; and
perform, via an individual neural network, a plurality of neural network calculations on the captured image to form an enhanced image having:
an increased resolution that is higher than the base resolution; and
an increased image quality that is higher than the base image quality.

2. The computing device of claim 1, wherein the processor resource is to perform the plurality of neural network calculations during inference.

3. The computing device of claim 2, wherein the processor resource is to perform the neural network calculations to balance an amount of increase in the increased resolution with an amount of increase in the increased image quality of the enhanced image.

4. The computing device of claim 3, wherein the neural network is a convolutional neural network (CNN) and wherein the plurality of neural network calculations are a plurality of CNN calculations.

5. The computing device of claim 4, wherein the CNN calculations include CNN calculations to:
segment, via a convolution layer of the CNN, the captured image into image dimensions having a given height and a given width;
pool, via a pooling layer of the CNN, the image dimensions to form pooled image dimensions;
extract features from the pooled image dimensions; and
perform subpixel convolution based on the extracted features and the pooled image dimensions to form the enhanced image.

6. The computing device of claim 1, wherein the increased resolution is 1.5 times or greater than the base resolution.

7. The computing device of claim 1, wherein the processor resource is to further to pool the image dimensions using atrous spatial pyramid pooling (ASPP).

8. A non-transitory memory resource storing machine-readable instructions stored thereon that, when executed, cause a processor resource to:
identify a base resolution of a captured image having a base image quality; and
perform, via an individual convolutional neural network (CNN), a plurality of CNN calculations on the captured image to form an enhanced image having an increased resolution that is higher than the base resolution and an increased image quality that is higher than the base resolution, the CNN calculations including CNN calculations to:
segment the captured image into image dimensions having a given height and a given width;
pool the image dimensions to form pooled image dimensions;
extract features from the pooled image dimensions; and
perform subpixel convolution based on the extracted features and the pooled image dimension to form the enhanced image.

9. The memory resource of claim 8, wherein the captured image has undergone lossy image compression to reduce an image resolution of the captured image from an original resolution to the base resolution.

10. The memory resource of claim 9, wherein the processor resource is to increase the image quality by:
sharpening feature boundaries dulled by the lossy image compression;
reduction of noise imparted by the lossy image compression;
reduction of compression artifacts imparted by the lossy image compression; or
any combination thereof.

11. The memory resource of claim 8, wherein the processor resource is to extract the features from the pooled image dimensions using a residual in residual dense block (RRDB) approach.

12. The memory resource of claim 8, wherein the processor resource is to determine:
an upsampling factor; and
utilize the upsampling factor to form the enhanced image.

13. A computing device, comprising:
an image capture device to capture an image with a base resolution and a base image quality; and
a processor resource to:
receive image data of an image from the image capture device; and
perform, via an individual convolutional neural network (CNN), a plurality of CNN calculations on the captured image to form an enhanced image having an increased resolution that is higher than the base resolution and an increased image quality that is higher than the base resolution, the CNN calculations including CNN calculations to:
segment the image data into image dimensions having a given height and a given width;
pool the image dimensions to form pooled image dimensions;
extract features from the pooled image dimensions; and
perform subpixel convolution based on the extracted features and the pooled image dimension to form the enhanced image.

14. The computing device of claim 13, wherein the processor resource is to further to:
pool the image dimensions to form the pooled image dimensions using atrous spatial pyramid pooling (ASPP); and
extract the features from the pooled image dimensions using a residual in residual dense block (RRDB).

15. The computing device of claim 13, wherein the computing device further comprises a first computing device that is communicatively coupled to and in a teleconference with a second computing device, and wherein the processor resource is to further to:
receive, during the teleconference, the image data of the image from an image capture device of the first computing device; and
provide the enhanced image to the second computing device during the teleconference.
